(19) United States
(12) Patent Application Publication
(10) Pub. No.: US 2004/0250276 A1
(43) Pub. Date: Dec. 9, 2004

(54) Wireless network entertainment and information device

(75) Inventors: John-Paul Pizana Cana, McKinney, TX (US); Nicholas Earle Brathwaite, Hayward, CA (US); Patrick Louis Meagher, Plano, TX (US)

Correspondence Address: Robert E. Krebs, THELEN REID & PRIEST LLP, P.O. Box 640640, SAN JOSE, CA, 95164-0640, US

(73) Assignee: Flextronics International USA, Inc.

(21) Appl. No.: 10/804,428

(22) Filed: Mar. 18, 2004

Related U.S. Application Data
(60) Provisional application No. 60/456,897, filed on Mar. 21, 2003.

(51) Int. Cl. H04N 7/173; H04N 7/16; G06F 13/00

(52) U.S. Cl. 725/37; 725/111; 725/134; 725/142

(57) ABSTRACT

A mobile entertainment and informational system includes cellular interconnectivity capability, a user interface for identifying music or video selections which can then be acquired through existing cellular networks. A CD/DVD player can be provided, along with a USB port for connection to a personal computer, for example to download selections therefrom. The unit can operate as a cellular telephone, a PDA (personal digital assistant), web browser, and music and video player.

### CROSS-REFERENCE TO RELATED APPLICATION

This application claims priority based on provisional Application Ser. No. 60/456,897, entitled “Wireless Network Entertainment And Information Device” by Nicholas Earle Brathwaite, Patrick Louis Meagher and John-Paul Pizana Cana, filed on Mar. 21, 2003, the contents of which are incorporated herein in their entirety.

### FIELD OF THE INVENTION

The present invention is directed to a mobile entertainment/informational unit. More specifically, the invention is directed to a wireless-based multi-purpose entertainment/informational system

### BACKGROUND

Typically, mobile entertainment units use radio signals to transfer information. For example, satellite-based radio is used to deliver audio products to consumers. However, such systems are unifunctional and unidirectional. This means only one product is delivered, and the flow of product is exclusively from the provider to consumer.

Other mobile entertainment systems require that the product be resident onboard for consumption. In this case, such examples include MPEG 3 (MP3) players. The aforementioned unit can only perform the particular function with the files that are already present in the device. To vary the selections, the player is typically coupled to a computer that already has the file present, and these files must then be downloaded to the target unit. When disconnected, no other files may be accessed other than those already present.

### SUMMARY OF THE INVENTION

In accordance with the invention, an apparatus for presenting audio and/or video selections to a user is provided. The apparatus includes a processor, a user interface, connected to the processor, through which the user identifies a particular audio and/or video selection, and a radio modem connected to the processor. The radio modem communicates the identity of the particular selection to a provider over a cellular network and receives the selection in electronic format from the provider via the cellular network. A presentation device is provided, which operates to present the particular selection to the user in audio and/or video form. The presentation device may include any or all of a set of speakers, and a display such as an LCD.

### BRIEF DESCRIPTION OF THE DRAWINGS

Many advantages of the invention will be apparent to those of ordinary skill in the art with a reading of this specification in conjunction with the attached drawings, wherein like reference numerals are applied to like elements and wherein:

FIG. 1 is a basic schematic block diagram of an embodiment of the invention;

FIG. 1A is schematic diagram of a system having a detachable LCD tablet in accordance with the invention;

FIG. 1B is a schematic diagram of a system adapted for connection an external audio system such as a car stereo;

FIG. 2 is a block diagram of a system in accordance with the invention;

FIG. 3 is a more detailed block diagram of a system in accordance with the invention;

FIG. 4 is a three-dimensional view of a system in accordance with the invention;

FIG. 5 is a three-dimensional view of an alternative system in accordance with the invention;

FIG. 6 is a three-dimensional view of another alternative system in accordance with the invention;

FIG. 6A is a view of a display in accordance with the invention;

FIG. 7 is a three-dimensional view of another alternative system in accordance with the invention, including a dockable LCD tablet;

FIG. 7A is side view of the system of FIG. 7, showing the swivelable nature of the docked LCD tablet.

### DETAILED DESCRIPTION OF THE INVENTION

The present invention contemplates a multi-functional mobile entertainment delivery system. The present invention also contemplates a multi-functional mobile digital data delivery system.

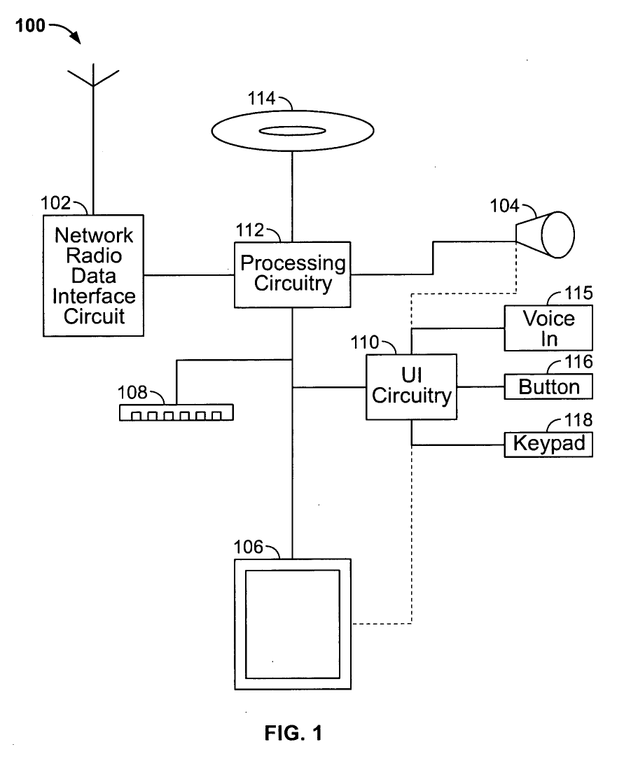

FIG. 1 is a schematic block diagram of an embodiment of the invention. A mobile entertainment system 100 has a wireless data interface 102. The interface 102 is coupled to a processing circuit 112.

The processing circuit 112 controls various aspects of the unit's functionality. This includes control of the various attaching circuits, performing system level functionality such as the storage of files, processing of user inputs, and processing of digital audio and/or video formats into audio and/or video signals.

An audio output 104 and a video output 106 are provided. A computer adapter port 108 is also present, as is a user interface circuit (UI) 110.

The UI 110 can include such features as buttons (116), a trackball (not shown), and keypad (118), all to facilitate the transfer of information between the user and the unit. These are by way of example only, and other devices normally used in the context of UI are known to those skilled in the art, and are included as well.

The adapter port (108) may be one such as a Universal Serial Bus (USB) port, or any of the same or related functionality, serving to connect the system 100 to another system (not shown), such as a desktop computer, for exchange of information therewith. Another adapter may be a network connection port, such as those typically employed in hard-wired data networks. Again, many types of couplings to personal computers or other devices are known, and are contemplated as being within the scope hereby described.

The system 100 is optionally provided with an external media adapter 114, allowing reading of external media directly, including for example compact discs (CD), digital video discs (DVD), or any other optical or magnetic media.

In practice, system 100 receives digital data from an external network through the interface 102. Radio modem technology utilizing cellular phone interconnectivity can be used for this purpose, as described below, wherein third-generation (3G) cellular phone connectivity are utilized. Such technology includes code-division multiple access (CDMA) technology, or for Universal Mobile Telecommunications System (UMTS) to receive and/or send digital data to an external information network. In this manner, the system 100 can obtain wireless real-time connectivity using existing cellular infrastructure.

During operation, the user makes selections through the UI 110. The user selects for instance a particular song, a particular format, or particular webcast-type material to listen to. The control circuit 112 interprets the user's selection, and initiates a request for the selection, which request is forwarded to network radio data interface circuit 102. The request is then communicated to the appropriate provider (not shown) through existing cellular channels in a conventional manner.

Sometime thereafter, the interface 102 receives the requested media through the conventional cellular network, and then proceeds with its presentation to the user, in video form through display 106, or audio form through speaker 104, or both.

As described, the system 100 may be employed to receive and play Internet “webcast” selections, download particular selections through compressed data files, such as MP3 files, or interact with other applications through the UI 110 the selections may be in streaming media form.

Alternatively or in addition, the system can be configured as a personal digital assistant (PDA), serving to provide a calendar, contacts repository, Internet browsing capability, e-mail access and interaction, and so forth. These functions can take place concurrently with the retrieval of other information, such as digital media for the songs in accordance with the process described above.

Thus the system integrates the functions of a media player and PDA, and cellular telephone (below) into one device. Relying on the media player function, the user can predefine a “playlist” of materials. The playlist may be defined through the interaction with a network through the wireless connection, or may be downloaded from an external source. In this case, when the playlist function is selected, the system fetches the individual files from a network and plays them in a particular order. Or the order may be randomized.

The UI 110 can contain a descriptive output, as well as user interaction functionality. The output may contain such items as network location information (URL), channel description, or playlist information. In this manner the user knows the particular source or contents of the session. The UI 110 output may also include other informational aspects, including temperature, location, and/or direction information, which can be obtained through the Internet or onsite, for example using a GPS (not shown) or digital thermometer (not shown).

The UI 110 may also couple to a keypad (not shown) for use as a data interface. Also the use of a menu selector or control apparatus (cursor control via a touch pad, for example) is contemplated. This would enable the user to traverse more easily through an interface.

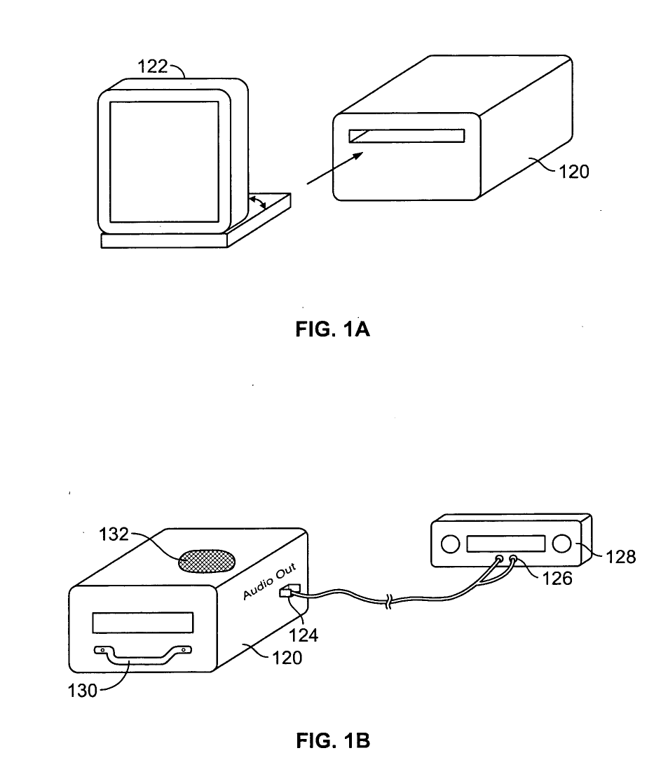

The UI 110 may couple to a detachable LCD tablet. This is shown more clearly in FIG. 2A, in which the system is housed in housing 120 into which LCD tablet 122 can be detachabley docked. In this manner, the system 100 may be used like many present network-enabled devices. The dockable LCD tablet 122 allows for easy storage and portability. The LCD tablet 122 may also be swivelly attached to the unit to allow viewing from multiple points, as well as the ability to fold the tablet into a position approximately flush with the unit for easy storage. Swiveling action is indicated by the curved arrow in FIG. 2A. The LCD may be of the touchscreen type, wherein the surface of the LCD can be sensitive to contact by a user's finger or stylus, said contact driving the operation of the system in a known manner. This is particularly useful for operation as a telephone keypad, wherein a keypad is displayed on the LCD screen 122, and the user simply “dials” the desired number or operation by touching the displayed buttons.

Further, a wireless link between the LCD tablet 122 and any audio output device may be used. In this case, such technology as that found in the Bluetooth™ protocol may be employed to make the link between the functional units.

It is contemplated that the system 100 provide cellular telephone functionality which can be voice-activated. In the latter case, a voice in device 115 (FIG. 1), such as a microphone, converts user voice input to electrical signals which processing circuitry 112 can interpret, using known voice recognition algorithms, to executable cellular telephone commands. These include commands to dial voice-entered telephone numbers, or memory-stored telephone numbers, or to perform myriad other modern cellular telephone functions. The voice activation may be used to toggle the unit into “cell phone” mode, or to trigger a speaker mute function for the entertainment system.

Communication with other telephones or devices can take place through either a hard-wired network link or through the underlying wireless link using existing wireless cellular infrastructure.

The microphone 115 also allows for broad functionality for the unit, such as voice activated radio tuning or selection capabilities.

Power to the system 100 can be applied from an internal source (not shown) or from an external source, such as an automobile lighter outlet. When intended for use in an automobile, the ability to interface the outgoing audio from system 100 directly into the auto entertainment system and employ the speakers already present can be readily provided. As seen in FIG. 2B, audio output 124 of unit 120 is coupled to audio input 126 of the auto entertainment system 128.

Alternatively or in addition, unit 120 can be provided with a handle 130, a speaker 132, and a battery pack (not shown). The unit 120 could alternatively be dockable to a slot in an automobile or automobile audio system, allowing the unit to be swapped in and out of the automobile. The same unit could be used as a combination personal digital assistant/cellphone/personal stereo system appliance.

FIG. 2 is a basic schematic diagram of the system showing more detail than the schematic block diagram of FIG. 1. A unit 200 contains a digital signal processing (DSP) circuit 204, and may also have a dedicated network audio processor (not shown), capable of processing digital audio files obtained over the network connection.

A display 208 and a stereo output port 210 are provided, as is a personal computing interface 212. An audio-in circuit 214 is provided, allowing data to be input from an external source, such as a compact disc, digital video disc, other optical media, or magnetic media. The unit may also have an onboard memory in a readable and writable form, such as a hard disk, or flash memory, or other persistent storage devices.

The processing circuit is coupled to a radio modem 216. In one embodiment, the radio modem 216 couples the unit to a PCS/cellular radio 217. The connection may for example a UMTS connection, or through 1×RTT technology. An optional microphone 218 and speaker 220 may be coupled to the modem 216, allowing the user to access the unit at the cell phone level and use the unit directly as a cell phone.

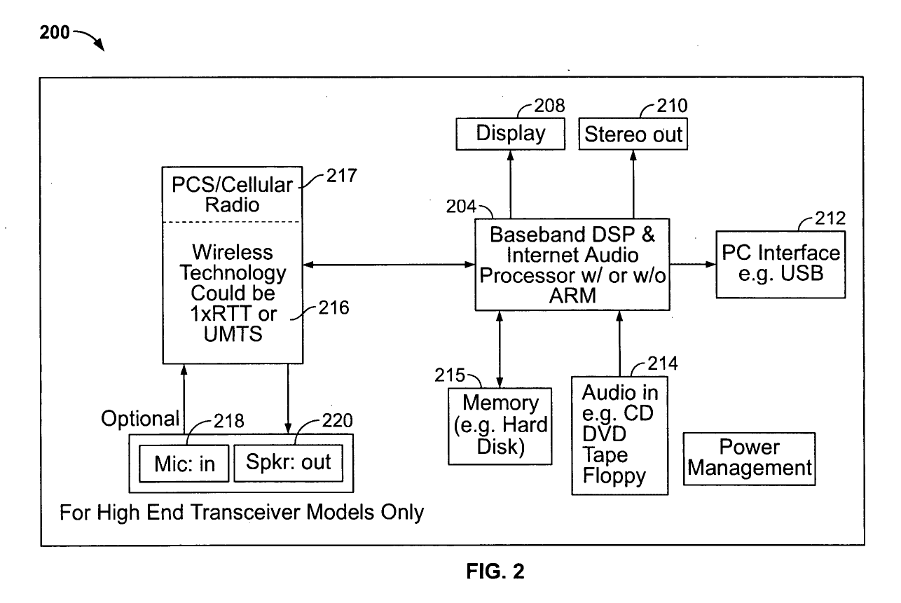

FIG. 3 is a detailed schematic diagram showing specific devices (boxes) which can be used to implement the invention. It will be appreciated some or all of these devices can be replaced with others from the same or different vendors to provide similar overall functionality without departure from the spirit and scope of the invention. This functionality includes the ability to access media directly, connection to a personal computer or similar processing device, an LCD display and keypad buttons, audio output, and the presence of persistent storage.

As seen in FIG. 3, the system includes a digital signal processor 301 performing the control and coordination functions of different devices and capabilities. Persistent storage devices such as a removable flash memory 303 and hard disk 305 provide storage capacity for the system, while a DRAM 307 enables fast memory access. ACD (Compact Disc) decoder is provided, for interface with playback device 309 for CD audio, CD-ROM, CD-R or similar media storage. Communicating with processor 301 are various user interface devices, including loudspeaker 311, headset 313, microphone 315, keypad buttons 317, and LCD device 319. A USB port 321 enables connection to other devices such as a personal computer (not shown).

The system of FIG. 3 couples to a network connection via the use of the DSP and a mobile station modem 323. Communication with the cellular network is performed in a convention manner via mobile station modem 323. The audio inputs and outputs can be coupled directly to the modem (line 331), allowing the modem to be used directly in the cellular phone mode. Supporting components include a power manager 325 and baseband-to-RF and RF-to-baseband processors 327 and 329.

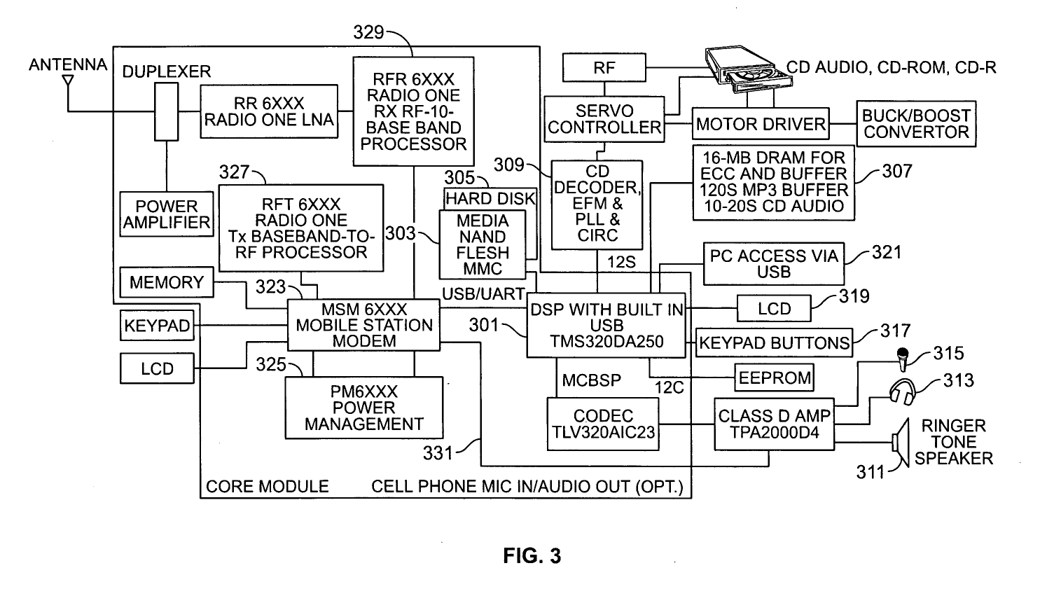

FIGS. 4, 5, 6, and 7 detail external features of various units in accordance with the invention. In FIG. 4, a unit 400, particularly adapted for use in an automobile, is shown. Unit 400 is provided with a slot 401 for access to a CD. A keypad MMI 403 for cellular phone and data interface is also provided, including talk/net/end button(s) 404. Further, a menu/feature selector control 405 is provided. A USB port 407 and a removable mini disk drive 409 are shown. LCD display 411 can show for example web/html/channel descriptions, temperature, direction, and so forth.

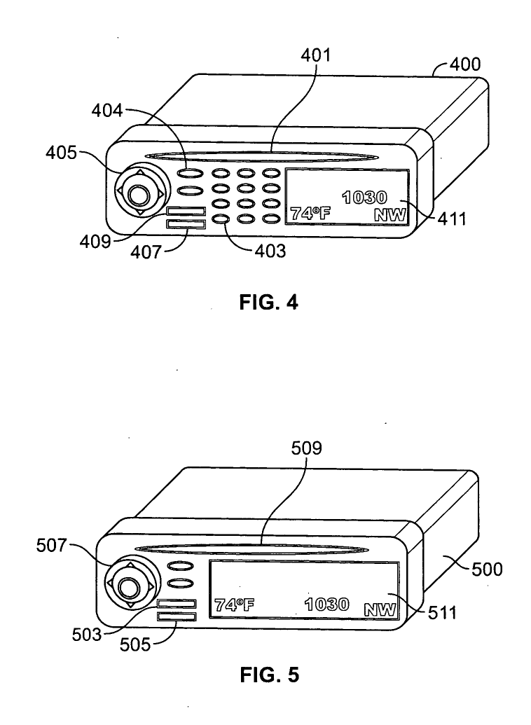

In FIG. 5, unit 500 with fewer features is shown. These features include a display 501, a menu/feature selector control 503, a USB port 505, a removable mini disk drive 507, a slot 409 for access to a CD, and an LCD display 511.

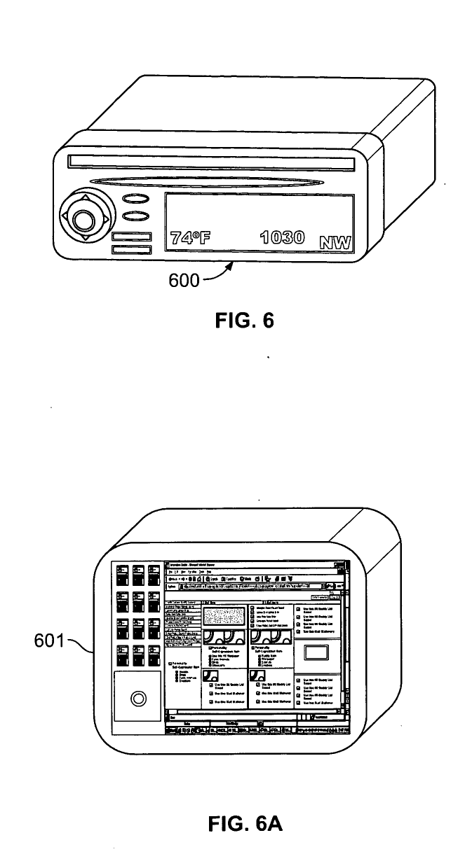

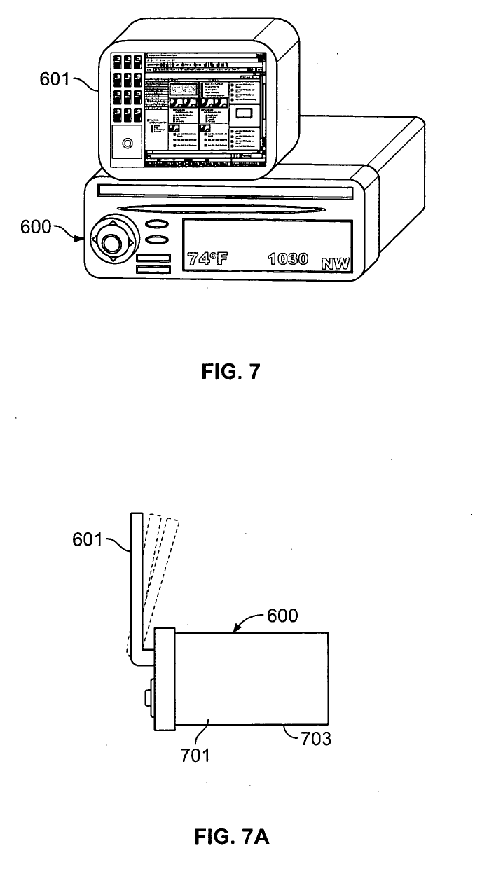

FIGS. 6 and 6A show a unit 600 having a dockable LCD tablet 601. FIG. 7 shows the unit 600 with the LCD tablet docked in position. FIG. 7 is a side view of the unit in FIG. 7, and shows the swiveling action of the dockable LCD tablet 601. Also shown in FIG. 7A is are detachable speaker 701 and battery pack 703.

The above are exemplary modes of carrying out the invention and are not intended to be limiting. It will be apparent to those of ordinary skill in the art that modifications thereto can be made without departure from the spirit and scope of the invention.

1. An apparatus for presenting audio and/or video selections to a user, comprising:
a processor;
a user interface, connected to the processor, through which the user identifies a particular audio and/or video selection;
a radio modem connected to the processor, the radio modem communicating the identity of the particular selection to a provider over a cellular network and receiving the selection in electronic format from the provider via the cellular network; and
a presentation device operating to present the particular selection to the user in audio and/or video form.

2. The apparatus of claim 1, further comprising an optical media reader connected to the presentation device, the optical media relating to audio and/or video information presentable by the presentation device.

3. The apparatus of claim 2, wherein the optical media is a music compact disc and/or DVD.

4. The apparatus of claim 1, further comprising magnetic media reader connected to the presentation device, the magnetic media relating to audio and/or video information presentable by the presentation device.

5. The apparatus of claim 1, further comprising a persistent storage media reader.

6. The apparatus of claim 5, wherein the persistent storage media is a removable flash memory.

7. The apparatus of claim 1, wherein the particular selection is obtained via the Internet.

8. The apparatus of claim 1, wherein the radio modem uses cellular telephone interconnectivity.

9. The apparatus of claim 8, wherein the radio modem is configured to establish a cellular telephone connection with another user.

10. The apparatus of claim 1, wherein the particular selection is received by the radio modem in streaming media form.

11. The apparatus of claim 1, wherein the particular selection is received by the radio modem as a compressed data file.

12. The apparatus of claim 1, wherein the processor is provided with Internet browsing capability.

13. The apparatus of claim 1, wherein the processor is configured as a personal digital assistant and includes contacts storage and calendaring capabilities.

14. The apparatus of claim 1, wherein the processor is provided with email capability such that email can be transmitted and received by the processor.

15. The apparatus of claim 1, further comprising a connection port for connecting the processor to a data source for transfer of data to and from the data source.

16. The apparatus of claim 1, wherein the connection port is a USB port.

17. The apparatus of claim 1, further comprising a detachable LCD tablet.

18. The apparatus of claim 1, wherein the detachable LCD tablet communicates with the processor wirelessly.

19. The apparatus of claim 1, wherein the user interface includes a microphone, the processor being configured to recognize voice input received through the microphone.

20. The apparatus of claim 1, wherein the user interface includes a touchpad.

21. An apparatus for presenting audio and/or video selections to a user, comprising:
processing means;
means for enabling the user to identify a particular audio and/or video selection;
means connected to the processing means for communicating the identity of the particular selection to a provider over a cellular network and receiving the selection in electronic format from the provider via the cellular network; and
means for presenting the particular selection to the user in audio and/or video form.

22. The apparatus of claim 21, further comprising means for reading optical media connected to the presentation device, the optical media relating to audio and/or video presentable by the means for presenting.

23. The apparatus of claim 22, wherein the optical media is a music compact disc and/or DVD.

24. The apparatus of claim 21, further comprising means for reading magnetic media connected to the means for presenting, the magnetic media relating to audio and/or video information presentable by the means for presenting.

25. The apparatus of claim 21, further comprising means for reading persistent storage media.

26. The apparatus of claim 25, wherein the persistent storage media is a removable flash memory.

27. The apparatus of claim 1, wherein the particular selection is obtained via the Internet.

28. The apparatus of claim 21, wherein the means for communicating and receiving uses cellular telephone interconnectivity.

29. The apparatus of claim 28, wherein the means for communicating and receiving is configured to establish a cellular telephone connection with another user.

30. The apparatus of claim 31, wherein the particular selection is received by the means for communicating and receiving in streaming media form.

31. The apparatus of claim 31, wherein the particular selection is received by the means for communicating and receiving as a compressed data file.

32. The apparatus of claim 31, wherein the processing means is provided with Internet browsing capability.

33. The apparatus of claim 31, wherein the processing means is configured as a personal digital assistant and includes contacts storage and calendaring capabilities.

34. The apparatus of claim 31, wherein the processing means is provided with email capability such that email can be transmitted and received by the processing means.

35. The apparatus of claim 31, further comprising a means for connecting the processing means to a data source for transfer of data to and from the data source.

36. The apparatus of claim 31, wherein the means for connecting is a USB port.

37. The apparatus of claim 31, further comprising a detachable display means.

38. The apparatus of claim 31, wherein the detachable display means communicates with the processing means wirelessly.

39. The apparatus of claim 31, wherein the user interface includes a microphone, the processing means being configured to recognize voice input received through the microphone.

40. The apparatus of claim 31, wherein the user interface includes a touchpad.
